(19) United States
(12) Patent Application Publication
(10) Pub. No.: US 2006/0075064 A1
(43) Pub. Date: Apr. 6, 2006

(54) Concurrent ftp read and write

(75) Inventors: Susann Marie Keohane, Austin, TX (US); Gerald Francis McBrearty, Austin, TX (US); Shawn Patrick Mullen, Buda, TX (US); Jessica Kelley Murillo, Hutto, TX (US); Johnny Meng-Han Shieh, Austin, TX (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(73) Assignee: International Business Machines Corporation, Armonk, NY (US)

(21) Appl. No.: 10/955,181

(22) Filed: Sep. 30, 2004

(51) Int. Cl. G06F 15/16

(52) U.S. Cl. 709/217

(57) ABSTRACT

Methods, systems, and media are disclosed for concurrent ftp transfer of a file. In one embodiment, the method for concurrent ftp reading and writing includes uploading a file by a first computer system in communication with an ftp site, such as a server, having an ftp program. Further, the method includes receiving, by the ftp site, a plurality of file segments of the file during the uploading. Further still, the method includes downloading, by a second computer system in communication with the ftp site, all of the plurality of file segments, whereby the downloading may begin during such receiving, i.e., before complete upload of the file. An intermediary ftp program associated with the ftp daemon of the ftp program permits the concurrent reading and writing of the file. Possible implementations of this intermediary ftp program include, for example, into either the ftp daemon or the logical file systems layer.

### FIELD OF INVENTION

The invention generally relates to concurrent ftp reading and writing of a file. More particularly, the invention relates to methods, systems, and media for concurrent ftp uploading and downloading of a file via a program implemented, for example, in either the ftp daemon or the logical file systems (“LFS”) layer.

### BACKGROUND

Individuals and businesses often desire to transfer files, such as data, text, programs, directories, and so on, to another person or business. A well-known protocol, that is, an agreed-upon format, to facilitate a transfer of a file is file transfer protocol (“ftp”).

Long before the advent of the World Wide Web, ftp was in wide use. Ftp is a way for a user to login with optional security to an Internet website for purposes of retrieving and/or sending files. Like hypertext transfer protocol (“HTTP”) for web pages, ftp uses transmission control protocol/internet protocol (“tcp/ip”) to enable data transfer in the form of packets from a server across the Internet between one or more hosts, i.e., client workstation(s). Unlike ftp, where entire files are transferred from one device, such as a client workstation, to another, such as an ftp server, and copied into memory, HTTP only transfers the contents of a webpage into a browser for viewing—a one-way system as files are transported only from the server back onto the client workstation's browser. Ftp, however, is a two-way system because files are transferred back and forth between the server and client workstation(s). In addition, when “http” appears in a uniform resource locater (“URL”), this means that the user is connecting to a web server, and not a file server, which is the case with ftp.

Oftentimes, people and businesses use ftp to transfer files between themselves to remove granting broad-brush access to their respective computer systems. That is, ftp provides a mechanism for users to transfer a file through an ftp server located at a neutral or partitioned site, whereby one user logins to the ftp server to upload the file and another user logins to download the same file. If no security beyond login is required for the ftp site, then the site is called an anonymous ftp site; otherwise, the site is a private ftp site, which may be owned by a neutral third party, such as data management company having no relation to the two separate businesses involved in uploading and downloading the file to the private ftp site.

Commercially available programs for ftp exist. Some examples are Ipswitch's WS_FTP®, KnoWare's Internet Neighborhood®, and Fetch Softworks' Fetch™. Despite these ftp programs providing transfer of a file from an ftp server between clients, problems remain. Oftentimes, using these or similar ftp programs, one user phones or emails another user and says that the file will be uploaded to an ftp site having a mutually known and accessible URL. The user may promise to phone or email the downloading user after the file upload is complete, whereupon the downloading user may login to download the fully uploaded file from the ftp site. With the frenetic pace of modern business, however, such courtesy calls or emails rarely occur. As a result, the downloading user needlessly waits for word from the user that the file is fully uploaded before download is possible. Even if the user never makes such a promise to the downloading user, the user must still fully upload the file to the ftp site before the downloading user may begin downloading the file. The interstitial time between full upload and download is especially large, a negative consequence, for large files and/or low bandwidth connectivity during uploading. What is needed, therefore, are quicker methods, systems, and media that also remove reliance on a user's full upload, as well as full upload notifications, of a file to an ftp server before another user may download the same file from the ftp site.

### SUMMARY OF THE INVENTION

Embodiments of the invention generally provide methods, systems, and media for concurrent ftp reading and writing of a file. In one embodiment, the method includes uploading a file by a first computer system in communication with an ftp site, such as a server, having an ftp program. Further, the method includes receiving, by the ftp site, a plurality of file segments of the file during the uploading. Further still, the method includes downloading, by a second computer system in communication with the ftp site, all of the plurality of file segments, whereby the downloading may begin during the receiving of the file segments, i.e., before complete upload of the file.

In another embodiment, the invention provides a system for concurrent ftp reading and writing of a file. The system generally includes a first computer system having a file and in communication with an ftp site. Further, the system includes a second computer system in communication with the ftp site. Further still, the system includes an ftp program, on the ftp site, for receiving an upload of the file in file segments, and for permitting a download, to the second computer system, of the file to begin after receiving, by the ftp site, a first of the file segments.

In yet another embodiment, the invention provides a machine-accessible medium containing instructions for ftp concurrent transfer of a file, which when executed by a machine, cause the machine to perform operations. The instructions generally include operations for uploading a file by a first computer system in communication with an ftp site, such as a server, having an ftp program. The instructions further include operations for receiving, by the ftp site, a plurality of file segments of the file during the uploading. Further still, the instructions include operations for downloading, by a second computer system in communication with the ftp site, all of the plurality of file segments, whereby the performing the downloading may begin during the receiving of the file segments, i.e., before complete upload of the file.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts an overview of a system for ftp transfer of a file in accordance with the disclosed invention.

FIG. 2 depicts an example embodiment of a system for ftp transfer of a file in accordance with the disclosed invention.

FIG. 3 depicts another example embodiment of a system for ftp transfer of a file in accordance with the disclosed invention.

FIG. 4 depicts an example embodiment of a flowchart for ftp transfer of a file in accordance with the disclosed invention.

### DETAILED DESCRIPTION OF THE EMBODIMENTS

The following is a detailed description of example embodiments of the invention, a description further enhanced by the accompanying drawings. The embodiments are examples and are in such detail as to clearly communicate the invention. However, the amount of detail offered is not intended to limit the anticipated variations of embodiments; on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

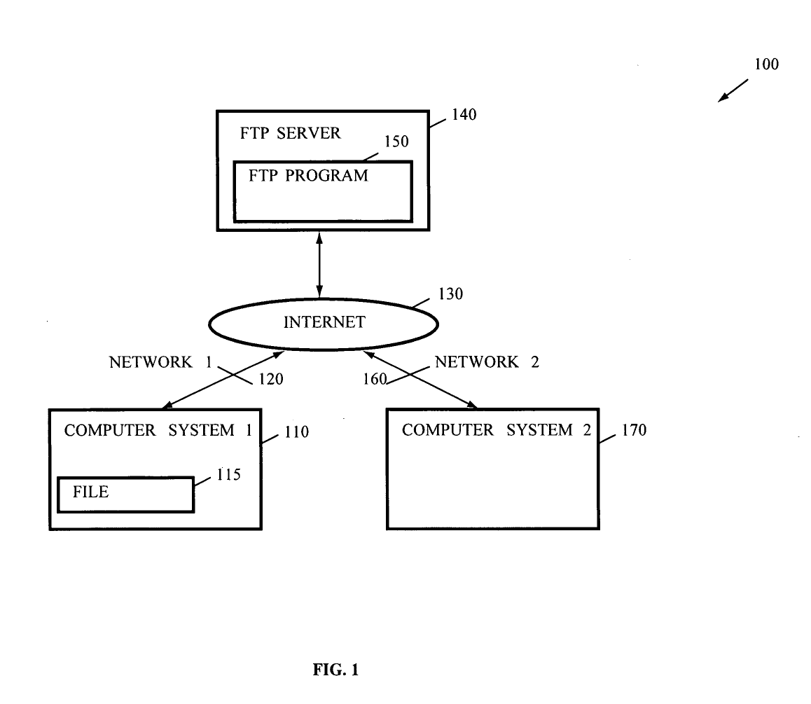

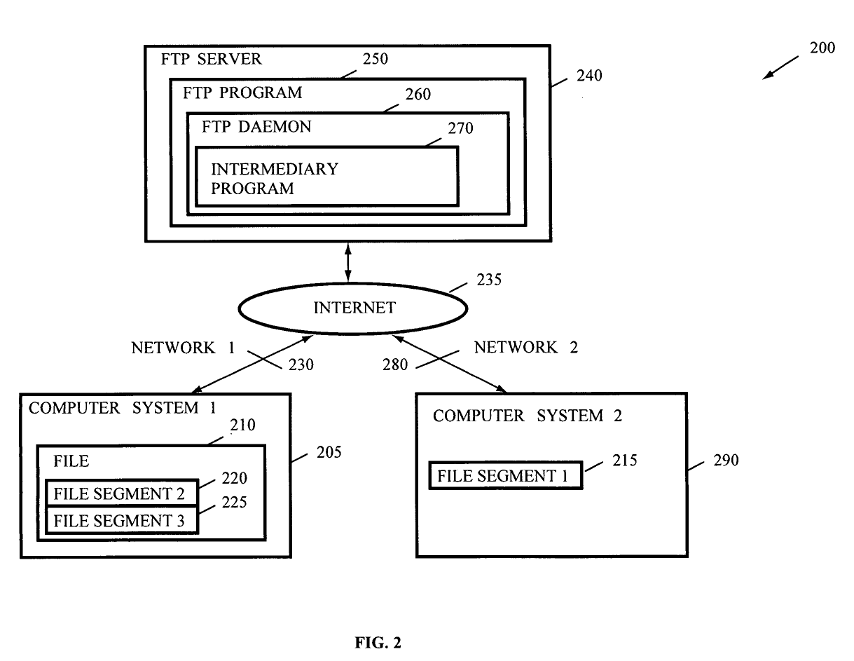

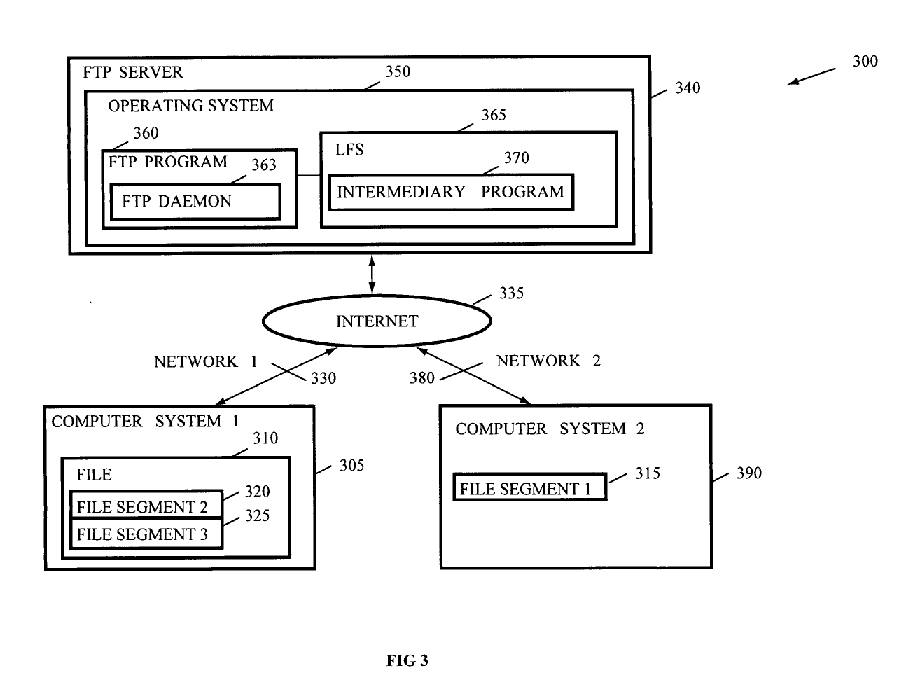

Generally speaking, systems, methods, and media for transferring a file via file transfer protocol (“ftp”) are contemplated. Referring to FIG. 1, this figure presents a general overview of a system 100 for ftp and the invention at hand. The system 100 includes a computer system-1 110, which includes, for example, an array of logical and physical peripherals both internal and external to a computer having a cpu. Computer system-1 110, which may be a client workstation, communicates by network-1 120 via a tcp/ip connection over the Internet 130 with an ftp site associated with an ftp server 140 for transfer of a file 115. The ftp server 140 includes an installed ftp program 150, such as Ipswitch's WS_FTP®, KnoWare's Internet Neighborhood®, and Fetch Softworks' Fetch™, which supplies the logic for file 115 transfer, i.e., upload of the file 115 from computer system-1 110 and download of the file 115 to computer system-2 170. Conventional transfer of a file 115 through an ftp program 150 requires complete upload of the file 115 from computer system-1 110 before computer system-2 170 may download the file 115 from the ftp server 140 through computer system-2's 170 network-2 connection 160 to the Internet 130. The disclosed invention, however, associates further enabling logic to a conventional ftp program 150, or, is integrated into a conventional ftp program 150 to form a new ftp program, either of which obviates the need to fully upload a file 115 to an ftp server 140 before download of the file 115 may begin. Although this enabling logic is not depicted in FIG. 1, it is in FIGS. 2 and 3, and is termed an “intermediary program.” As a result of this “intermediary program,” ftp transfer of a file 115 is quicker, but only if computer system-2 170 chooses to download the uploaded file 115 as soon as uploaded file segments of the file 115 become available for download.

Turning now to FIG. 2, a more detailed discussion of the invention ensues. Like FIG. 1, FIG. 2 depicts computer system-1 205, which a user may use for transfer of the file 210 to an ftp server 240. In this client-server scenario, transfer, here, upload, of the file 210 occurs from computer system-1 205 through network-1 via tcp/ip connection to an ftp site on the Internet 235. The ftp site is a mutually known URL accessible by network-1 230 and network-2 280 by computer system-1 205 and computer system-2 290, respectively. The ftp site is associated with an ftp server 240 having an ftp program 250, which enables the transfer of the file 210. However, before actual file 210 transfer, whether upload or download, the ftp program 250 often requires a user to login, which may include the user supplying a user name. Further, the ftp program 250 may optionally require a password to ensure secure access to the ftp server 240, and, if so, the ftp program 250 grants access for file 210 transfer after authentication.

Enabling logic reduced to hardware and/or coded in software is found in an intermediary program 270 that is integrated into or associated with the ftp program 250. As shown in FIG. 2, the intermediary program 270 is integrated into the ftp program 250, but in FIG. 3, the intermediary program 370 is associated with the ftp program 360. Although FIGS. 2 and 3 show two different embodiments for location of the intermediary program 270, 370 with respect to the ftp program 250, 360, it is understood that these are just two example embodiments of the invention, and other locations of the intermediary program are possible without departing from the scope of the invention.

Returning to FIG. 2, the intermediary program 270 is depicted as located within, i.e., integrated into, the ftp daemon 260 of the ftp program 250. The ftp daemon 260 is the part of the ftp program 250 that listens for the tcp/ip connection by computer system-1 205 and computer system-2 290 from their respective networks 230, 280 for file 210 transfer. Further, the ftp daemon is also the part of the ftp program 250 that says follow ftp protocol to pull or push the data down, such as file segments 215, 220, and 225 of a file 210 undergoing transfer. Although it is somewhat redundant to say that the ftp daemon 260 is on the server side, i.e. the ftp server 240, because a daemon is always on the server side in ftp terminology, “ftp daemon” 260 is used in this disclosure to ensure clarity.

Now, turning to the functionality imparted to the invention by the intermediary program 270 associated with the ftp daemon 260 and integrated into the ftp program 250, the intermediary program 270 permits download of a file 210 to begin before full upload of the file 210. FIG. 2 depicts an example embodiment of this intermediary program's 270 functionality. Specifically, as shown, a user of computer system-1 205 is in the middle of uploading a file 210 to the ftp server 240. Since computer system-1's 205 tcp/ip network-1 connection involves transfer of a file 210 in discrete file subparts, or in tcp/ip terminology “packets,” the file 210 is uploaded to the ftp server 240 by the ftp program 250 in collections of packets referred to in this disclosure as file segments. Working in tandem with the ftp daemon 260, the intermediary program 270 manages the receipt of file segments uploaded by computer system-1 205 and available for download by computer system-2 290, which may be one or even a plurality of computer systems desiring to download the file 210. As shown in FIG. 2, the intermediary program 270 has permitted the ftp daemon 260 to query the intermediary program 270 and to partially download file 210 to computer system-2 290 from the ftp server 240 before computer system-1 205 fully uploads the file 210 to the ftp server 240. This is pictorially shown in FIG. 2 by file segment-1 215 appearing within computer system-2 290, and file segment-2 220 and file segment-3 225 of file 210 still appearing within computer system-1 205.

After downloading file segment-1 215 and/or expiration of a finite period of time, the ftp daemon 260 may re-query the intermediary program 270 for the availability of downloading any and all other packets, i.e., file segments, which were not yet downloaded to computer system-2 290. In tcp/ip protocol, a period of non-response is perfectly acceptable because what happens is computer system-2's 290 tcp connection says, ah, maybe that packet was lost, so the packet should be re-sent, when, in truth, the ftp daemon 260 may have never sent that packet or file segment. This re-querying may occur once or multiple times until computer system-2 290 receives file segments-1, -2, -3 215, 220, 225, wherein file segment-3 225 includes an end-of-file tail in a packet, which tcp understands is the end of the uploaded file 210 for downloading by the system 200.

Turning now to FIG. 3, a system 300 is depicted that includes an intermediary program 370, which imparts the same functionally for ftp transfer of a file as the intermediary program 270 in FIG. 2's system 200. FIG. 3's implementation of the intermediary program 370 is different than FIG. 2's, and to avoid mere repetition, discussion of system 300 solely revolves around this difference in implementation of intermediary program 370.

In FIG. 3, an ftp program 360 resides on an ftp server 340, which is associated with an ftp site having a URL mutually known and accessible to computer systems 305, 390 through their respective networks 330, 380 via tcp/ip communication over the Internet 335. The ftp server 340 includes an operating system 350, as does system 200 in FIG. 2 but is not depicted, which is a general purpose program on top of which other programs, called application programs, can run. Two such application programs are ftp program 360 and intermediary program 370 in FIG. 3. Unlike the system 200 in FIG. 2, system 300 in FIG. 3 has the intermediary program 370 implemented into the logical file systems (“LFS”) 365 layer of the operating system 350, wherein the intermediary program 370, enabled by logic reduced to hardware and/or in code, communicates with the ftp program 360 to permit download of the file 310 to begin before full upload of the file 310 to the ftp server 340.

Within an operating system 350, there are different file systems, such as LFS 365, NFS, DFS, JFS, and JFS2. LFS 365 sits above these and all other file systems, and is responsible for making all of the underlying file systems have one appearance. Whenever a user wants to begin use of a program, such as ftp program 360, the first call is to “file open,” and this call goes to LFS 365. LFS 365 recognizes what type of file system is associated with a particular program, and, for example, it is a JFS file system, then LFS 365 calls down to JFS file system in order to handles all the v-node, i-node intricacies, going to disk, etc., functionalities for operation of the program, such as the ftp program 360. With the intermediary program 370 residing in LFS 365, LFS 365 sees the ftp daemon 363 do the connection down for the read from computer system-1 305. LFS 365 knows that there is already an open file for writing, i.e., uploading, the file 310 onto the ftp server 340. Instead of ftp daemon 363 throttling the download of file 310 to computer system-2 390 through the intermediary program 370, as is the case in FIG. 2, LFS 365 throttles the download in the system 300 depicted in FIG. 3. That is, ftp daemon 363 keeps calling to the LFS 365, saying that more data, in terms of file segments, needs to be read. So, the ftp daemon 363 issues a read, and if no response is received within expiration of a finite period of time, then the ftp daemon 363 sits idle in a wait mode until the LFS 365 responds with more data in the form of file segments 315, 320, 325 until all file segments 315, 320, 325 are downloaded to computer system-2 390 by the intermediary program 370.

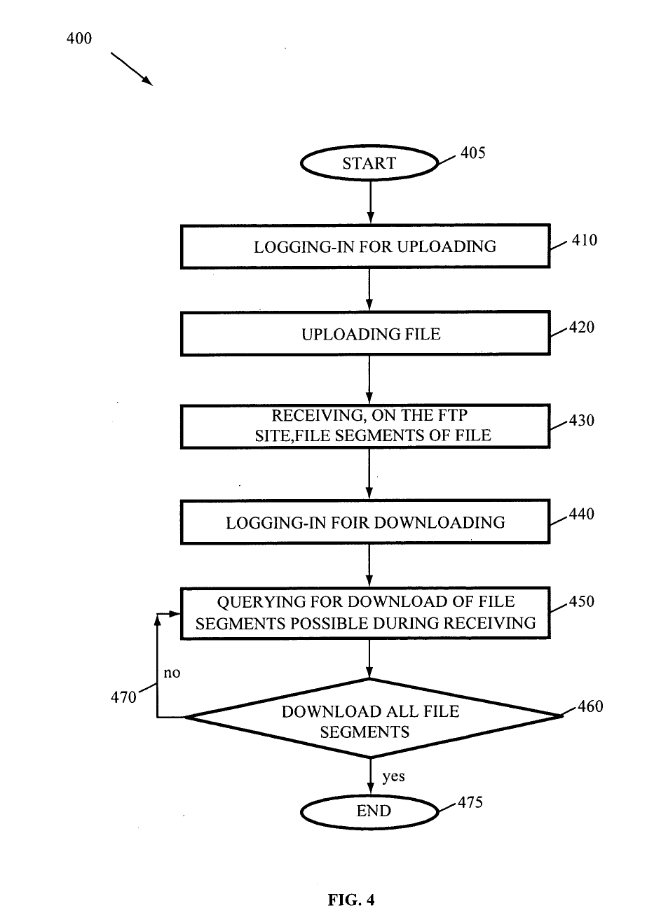

Now, moving to FIG. 4, a flowchart 400 for ftp transfer of a file is depicted for a system such as systems 200 and 300 in FIGS. 2 and 3, respectively. Flowchart 400 begins at START 405 by a user of a first computer system logging in 410 over the Internet and in tcp/ip network communication with an ftp server located at a URL. Logging in 410 entails a user providing a userid, and, optionally, a password, which the ftp server authenticates in order to allow access and upload a file to the ftp server. Logging in 440 by another user of a second computer system involves a similar process as logging in 410, except that logging in 440 is for download of at the least partially uploaded from the ftp server through the second computer system's network connection over the Internet to the same URL.

After the first computer system is logged into 410 the ftp server, an ftp daemon of the ftp program uploads 420 the file through the first computer system's tcp/ip communication with the ftp server. Uploading 420 of the file occurs in file segments, or in tcp/ip parlance, packets. Whether the intermediary program is integral to an ftp program by its implementation into the ftp program, or the intermediary program is associated with the ftp program through its implementation into the LFS layer of the operating system on the ftp server, the intermediary program receives 430 the packets for ultimate download by a second computer system. In the former implementation, the ftp daemon of the ftp program throttles, i.e., queries 405, the received 430 packets available for download by the intermediary program to the second computer system. In the latter implementation, the LFS throttles, i.e., 450, the ftp daemon of the ftp program for the received 430 packets available for the download by the intermediary program to the second computer system. In either case, what is important is that download of the file to the second computer system may begin before the file is fully uploaded by the first computer system to the ftp server.

Flowchart 400 continues by a decision block 460 that queries whether all file segments or packets associated with the file were downloaded to the second computer system. If yes, then the flowchart 400 reaches an END 475, which, in tcp/ip parlance is recognized by the final downloaded packet containing an end of file tail. If download of all of the file segments or packets has not occurred, which is depicted on FIG. 3 with 470, “no,” and a back connecting arrow to querying 450. As such, depending on the implementation of the intermediary program, the intermediary program causes either the ftp daemon or the LFS to again query for yet non-received packets or file segments for downloading to the second computer system. The second computer system likely views these non-received packets as lost, but, in all likelihood, the ftp server did not yet receive these packets in the upload of the file, and, as a result, the second computer system could not download these yet non-received packets. This iteration, as shown by 470, continues until the all packets or file segments are downloaded by the second computer system from the ftp server.

Another embodiment of the invention is implemented as a program product for use with a computer system such as, for example, the systems 100 and 200 shown in FIGS. 1 and 2. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

While the foregoing is directed to example embodiments of the disclosed invention, other and further embodiments of the invention may be devised without departing from the basic scope thereof, and the scope thereof is determined by the claims that follow.

What is claimed is:

1. A method for ftp transfer, the method comprising:
uploading, by a first computer system, a file to an ftp site;
receiving, by the ftp site, the file in file segments during the uploading; and
downloading, by a second computer system, the file segments during the receiving.

2. The method of claim 1, further comprising authenticating, by the ftp site, access for the file before the uploading or the downloading.

3. The method of claim 1, wherein the uploading and the downloading comprises connecting via one or more networks to the ftp site.

4. The method of claim 1, wherein the receiving and the downloading comprises managing, by an intermediary program associated with an ftp daemon, each of the file segments available for the downloading.

5. The method of claim 1, wherein the uploading and the downloading comprises reading and writing by an ftp daemon associated with a server on the ftp site.

6. The method of claim 1, wherein the downloading comprises querying by an ftp daemon for the file segments of the file.

7. The method of claim 6, wherein the querying comprises repeating the querying, after expiration of a finite period of time, for any of the file segments not received by the ftp daemon for the downloading and after the querying.

8. A system for ftp transfer, the system comprising:
a first computer system having a file and in communication with an ftp site;
a second computer system in communication with the ftp site; and
an ftp program, on the ftp site, for receiving an upload of the file in file segments, and for permitting a download, to the second computer system, of the file to begin after receiving, by the ftp site, a first of the file segments.

9. The system of claim 8, wherein the first computer system and the second computer system are in network communication with the ftp site.

10. The system of claim 8, wherein the ftp site comprises a URL associated with an ftp server.

11. The system of claim 8, wherein the ftp program comprises an ftp intermediary program for managing the file segments received by the upload and available for the download.

12. The system of claim 11, wherein the intermediary program is implemented into an ftp daemon of the ftp program.

13. The system of claim 11, wherein the intermediary program is implemented into a logical file systems layer that communicates with the ftp program.

14. A machine-accessible medium containing instructions, which when executed by a machine, cause the machine to perform operations for ftp transfer, comprising:
uploading, by a first computer system, a file to an ftp site;
receiving, by the ftp site, the file in file segments during the uploading; and
downloading, by a second computer system, the file segments during the receiving.

15. The machine-accessible medium of claim 14, wherein the instructions further comprise instructions to perform operations for authenticating, by the ftp site, access for the file before performing the uploading or the downloading.

16. The machine-accessible medium of claim 14, wherein the instructions for uploading and downloading comprises instructions for connecting via one or more networks to the ftp site.

17. The machine-accessible medium of claim 14, wherein the instructions for receiving and downloading comprises instructions for managing, by an intermediary program associated with an ftp daemon, each of the file segments available before performing the instructions for the downloading.

18. The machine-accessible medium of claim 14, wherein the instructions for uploading and downloading comprises instructions for reading and writing by an ftp daemon associated with a server on the ftp site.

19. The machine-accessible medium of claim 14, wherein the instructions for downloading comprises instructions for querying, by an ftp daemon, for the file segments of the file.

20. The machine-accessible medium of claim 19, wherein the instructions for querying comprises instructions for repeating the querying, after expiration of a finite period of time, for any of the file segments not received by the ftp daemon for the downloading and after the querying.
